(19) United States
(12) Patent Application Publication
(10) Pub. No.: US 2023/0053988 A1
(43) Pub. Date: Feb. 23, 2023

(54) POLYACRYLATE MATERIALS

(71) Applicant: GALATA CHEMICALS LLC, Jersey City, NJ (US)

(72) Inventors: Peter FRENKEL, Danbury, CT (US); Chris TURNBULL, Barrie (CA); Larry B. SIMMONS, Washington, WV (US)

(21) Appl. No.: 17/966,465

(22) Filed: Oct. 14, 2022

Related U.S. Application Data
(62) Division of application No. 16/982,085, filed on Sep. 18, 2020.
(60) Provisional application No. 62/644,659, filed on Mar. 19, 2018.

(51) Int. Cl. C08L 33/06; C08K 3/014; C08J 5/18; C08K 3/24; C08K 5/00; C08L 51/00

(52) U.S. Cl. CPC C08L 33/06; C08K 3/014; C08J 5/18; C08K 3/24; C08K 5/0016; C08L 51/003; C08J 2333/08

(57) ABSTRACT

A composition comprising:
(1) 0.1 to 84.0 wt % of a polymeric resin selected from PVC homopolymers, PVC copolymers, CPVC, PLA, SAN, ASA, CPE, EVA, ABS, MBS, polycarbonate, conventional acrylic ester polymers or mixtures thereof; and
(2) 16.0 to 99.9 wt % of a polyacrylate resin/material (PAM) composition comprising a polymer (A) phase and a polymer (B) phase present in a ratio of polymer (A) phase/polymer (B) phase of 50/50 to 90/10,
   polymer (A), having a glass transition temperature Tg below −40° C., comprising 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers, where the double bonds can be of the same or differing reactivity; and
   polymer (B), having a glass transition temperature Tg above 85° C., comprising a first polymeric component (B1) of one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof, and optionally a second polymeric component (B2) comprising 0.3 to 2.5 wt % based on the total weight of polymer (B) of one or more polyethylenically unsaturated monomers where the unsaturated bonds can be of the same or differing reactivity.

### FIELD OF THE INVENTION

The present invention relates to rigid, semi-rigid and plasticized polyacrylate-containing compounds that can be processed into transparent and opaque articles exhibiting high weather resistance, low volatility, low surface resistivity and a broad hardness range.

### BACKGROUND

Polyacylates are an important class of polymers that are soft and tough, since their glass transition temperatures are well below room temperature. They are known for their high transparency, good impact toughness and elasticity, and have reasonably good heat resistance. They also have good weatherability and ozone resistance since they do not have double bonds in the backbone. Polyacrylate esters of high molecular weight are commonly used as additives to other materials at about 1 to 15 phr (parts per 100 parts of a polymer resin), such as PVC, for improving processability, cell structure, and impact resistance characteristics, improving surface quality, raw material dispersion among others [Handbook of PVC Formulating, Edward J. Wickson, John Wiley & Sons Inc., 1993, pp 442-451, 581-587]. However, efforts to expand the usage range of polyacrylate compositions has been ongoing.

U.S. Pat. No. 4,508,875 discloses a multi-layer polymer composition. An inner layer polymer consisting of 50 to 100 parts by weight of alkyl acrylate and 0 to 50 parts by weight of alkyl methacrylate with a degree of swelling of 10 or lower and a glass transition temperature less than 10° C.

WO 2012165526A discloses an acrylic resin composition made of 100 parts by mass of a rubber-containing multi-stage polymer and 0 to 10 parts by mass of a thermoplastic polymer.

U.S. Pat. No. 8,618,191 discloses an acrylic-based resin composition comprised of two acrylic-based copolymers having a core-shell structure. The first comprises a rubber, including a bilayer structure with the inner layer a copolymer of acrylic-based compound and aromatic vinyl compound, and the outer layer an acrylic-based compound. The second copolymer has rubber structure comprised of a bilayered structure where the inner layer is polyalkyl(meth)acrylate and the outer later is an acrylic-based compound.

U.S. Pat. No. 9,422,426 discloses a transparent thermoplastic resin composition that includes 5 to 40 weight percent of an impact-reinforcing agent with a core-shell structure as well as 60 to 95 weight percent of an acrylic-based resin.

U.S. Patent Application 20140309374 discloses an acrylic resin film comprised of 10 to 70 parts by weight of high-fluidity acrylic resin, 10 to 70 parts by weight of high-rigidity acrylic resin and 5 to 20 parts by weight of an acrylic impact modifier based on 100 parts by weight of acrylic resin film.

Japanese Patent 2010013597A discloses a soft and weatherable acrylic film and sheet. The acrylic polymer mixture is composed of 10 to 80% by weight acrylic resin and 90 to 20 weight percent of acrylic rubbery particles.

U.S. Patent Application 20080090055 discloses a multilayer acrylic resin film composed of two surface layers made of acrylic resin. The acrylic resin is comprised of 20 to 100 weight percent methacrylic resin and 0 to 80 weight percent of acrylic rubber particles which contain a UV absorber at 0.2 parts by weight or less per 100 parts of acrylic resin composition.

U.S. Patent Application 20130184375A1 discloses a jet-black rubber modified acrylic resin composition comprised of 100 parts by weight of a rubber modified acrylic resin and 0.05 to 5 parts by weight of carbon black.

U.S. Patent Application 20140141270A1 discloses an acrylic resin composition, an acrylic resin sheet, and an acrylic resin laminate which all have excellent transparency and impact resistance. The acrylic resin composition comprised of 100 parts by mass of an acrylic polymer and 0.002 to 0.7 part by mass and olefin-alkyl (meth)acrylate copolymer. The acrylic polymer has 50 to 100% by mass methyl methacrylate units and 0 to 50% by mass of other vinyl monomer units.

Japanese Patent 4999100B2 discloses a (meth)acrylic resin film excellent in durability and optical characteristics. This (meth)acrylic resin film is composed of a cross direction central portion formed by a first resin composed of (meth)acrylic resin and a cross direction end portion formed by a second resin composed of a (meth)acrylic resin and at least one of a flexible acrylic resin, an acrylic rubber, and a rubber-acrylic graft core shell polymer.

Japanese Patent 1977154882A discloses a fiber glass reinforced polymethyl methacrylate resin plate that is prepared by impregnating a copolymer resin containing acrylic ester and methyl-methacrylate with glass fibers.

U.S. Pat. No. 3,793,402 discloses a multi-stage sequentially produced polymer. The thermoplastic composition includes 10 to 96 percent of a rigid thermoplastic polymer and 90 to 4 weight percent of a multi-stage sequentially produced polymer.

U.S. Pat. No. 6,310,137 discloses a multilayered acrylic polymer with improved transparency.

U.S. Patent Application 20170114215A1 discloses an acrylic resin composition composed of a rubber-containing multistage polymer with high weather resistance, flexibility, heat resistance and transparency. The multistage polymer contains 30% by mass or more of an elastic polymer. The acrylic resin composition is comprised of an elastic polymer obtained by polymerizing one or more of a monomer selected from alkyl acrylate with 1 to 8 carbon atoms and alkyl methacrylate having an alkyl group with 1 to 4 carbons. One polymer is obtained by polymerizing an alkyl methacrylate monomer, which has an alkyl group with 1 to 4 carbons, in the presence of the elastic polymer.

Nevertheless, the development of new rigid, semi-rigid and plasticized polyacrylic materials with improved performance characteristics that are suitable for a broad range of both outdoor and interior applications has continued.

### SUMMARY OF THE INVENTION

The subject matter of the present disclosure relates to rigid, semi-rigid and plasticized polyacrylate-containing compounds that can be processed into transparent and opaque articles exhibiting high weather resistance, low volatility, low surface resistivity and a broad hardness range.

In one embodiment, the present disclosure provides composition containing 0.1 to 84.0 wt % of a polymeric resin selected from PVC homopolymers, PVC copolymers, CPVC, PLA, SAN, ASA, CPE, EVA, ABS, MBS, polycarbonate, conventional acrylic ester polymers or mixtures thereof; and 99.9 to 16.0 wt % of a polyacrylate resin/material (PAM) composition comprising a polymer (A) phase and a polymer (B) phase present in a ratio of polymer (A) phase/polymer (B) phase of 50/50 to 90/10. Polymer (A) has a glass transition temperature Tg below −40° C., and comprises 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers, where the double bonds can be of the same or differing reactivity. Polymer (B), has a glass transition temperature Tg above 85° C., and comprises a first polymeric component (B1) and an optional second component (B2). First polymeric component (B1) contains one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof. Optional second polymeric component (B2) comprises 0.3 to 2.5 wt % based on the total weight of polymer (B) of one or more polyethylenically unsaturated monomers where the unsaturated bonds can be of the same or differing reactivity.

In another embodiment, the present disclosure provides an article produced from the above composition.

In still another embodiment, the present disclosure provides a process for compounding the above composition.

In another embodiment, the present disclosure provides a process for preparing an article from the above composition.

In an embodiment the present disclosure provides a composition comprising: (1) a polyacrylate resin/material (PAM) composition comprising a polymer (A) phase and a polymer (B) phase present in a ratio of polymer (A) phase/polymer (B) phase of 50/50 to 90/10. Polymer (A) has a glass transition temperature Tg below −40° C., and comprises 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers. Polymer (B), has a glass transition temperature Tg above 85° C., and comprises a first polymeric component (B1) and an optional second component (B2). First polymeric component (B1) contains one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof. Optional second polymeric component (B2) comprises 0.3 to 2.5 wt % based on the total weight of polymer (B) of one or more polyethylenically unsaturated monomers where the unsaturated bonds can be of the same or differing reactivity; and (2) an additive selected from plasticizer, heat stabilizer, UV absorber or mixtures thereof.

### DESCRIPTION OF THE INVENTION

It has unexpectedly been discovered that articles produced from particularly designed compositions containing a polyacrylate resin material, exhibit high weather resistance, low volatility, low surface resistivity and a broad hardness range. The polyacrylate resin material can be used alone or in combination with other polymer resins selected from PVC homopolymers, PVC copolymers, CPVC, PLA, SAN, ASA, CPE, EVA, ABS, MBS, polycarbonate, conventional acrylic ester polymers or mixtures thereof.

Polyacrylate Resin/Material (PAM)

The polyacrylate resin/material (PAM) comprises a polymer (A) phase and a polymer (B) phase present in a ratio of polymer (A) phase/polymer (B) phase of 50/50 to 90/10. Polymer (A) has a glass transition temperature Tg below −40° C., and comprises 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers. Polymer (B), has a glass transition temperature Tg above 85° C., and comprises a first polymeric component (B1) and an optional second component (B2). First polymeric component (B1) contains one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof. Optional second polymeric component (B2) comprises 0.3 to 2.5 wt % based on the total weight of polymer (B) of one or more polyethylenically unsaturated monomers.

The PAM material contains two distinct phases: an elastic polymer (A) phase and a harder polymer (B) phase. It can be used alone as the sole polymeric material or in combination with other polymeric resins. When present in combination with other polymeric resins PAM is typically present in an amount from 16.0 to 99.9 wt % based on the total weight of the composition. Preferably, the PAM material is present in an amount from 16.0 to 80.0 wt %, 25.0 to 75.0 wt % or 30.0 to 70.0 wt %, based on the total weight of the composition, with the remainder being the polymeric resin. More preferably, the PAM material is present in an amount of 30.0 to 50.0 wt %.

Polymer (A) has a glass transition temperature Tg below −40° C., preferably below −50° C. and contains 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers. Preferably, polymer (A) contains 97.0 to 99.5 wt % of the first polymeric component (A1) and 0.5 to 3.0 wt % second polymeric component (A2).

Examples of component (A1) monomers include ethyl acrylate, butyl acrylate, hexyl acrylate, 2-ethyl hexyl acrylate, octyl acrylate and mixtures thereof. Butyl acrylate and 2-ethyl hexyl acrylate are preferred. Butyl acrylate is most preferred.

Optionally, other monomers can be included with the alkyl acrylates in A1, such as, but not limited to, vinyl acetate, alkyl methacrylates, acrylic acid, methacrylic acid and the vinyl aromatic monomers such as styrene. When these are present it is preferred to be contained at greater than 1 to 5.0%.

Component (A2) monomers can be selected from a first group, second group, or both. Examples of component (A2) monomers from a first group include, but are not limited to, the dimethacylates like ethylene glycol dimethacrylate; 1,3-butanediol dimethacrylate; 1,4-butanediol dimethacrylate; diacrylates such as butylene glycol diacrylate, triacrylates like trimethylolpropane triacrylate (TMPTA), and di-vinyl compounds such as divinyl benzene. Examples of component (A2) monomers from the second group include diallyl methacrylate, allyl methacrylate, and allyl acrylate.

The dimethacrylate, divinyl benzene, and allyl (meth)acrylates are preferred. 1,3-Butanediol dimethacrylate, divinyl benzene and allyl methacrylate are most preferred.

The molecular weight of the stage or stages of polymer (A) can range from 0.5 million Daltons to 5 million Daltons, preferably, 0.5 to 3.0 million Daltons as determined by gel permeation chromatography on the elastic polymer phase prepared without the presence of the monomers A2.

The elastic polymer (A) of the multistage polymer has a mean particle size ranging between 70 and 250 nanometers, preferably to 100 to 250 nanometers.

Polymer (B), has a glass transition temperature Tg above 85° C., preferably above 90° C. and comprises a first polymeric component (B1) and an optional second component (B2). First polymeric component (B1) contains one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component selected from alkyl acrylates, vinylbenzene or substituted vinylbenzenes or mixtures thereof. Optional second polymeric component (B2) comprises 0.3 to 2.5 wt % based on the total weight of polymer (B), of one or more polyethylenically unsaturated monomers.

Examples of component (B1) monomers include monomers that are capable of forming a hard polymer with methyl methacrylate and include, but are not limited to, styrene, substituted vinyl aromatics, alkyl methacrylates, such as ethyl methacrylate, butyl methacrylate, t-butyl methacrylate and the like; alkyl acrylates, such as ethyl acrylate, butyl acrylate and the like; acrylic acid and methacrylic acid. The homopolymer of methyl methacrylate, and copolymers of it with styrene and butyl acrylate are most preferred.

Monomers of the component (B2) contain multiple unsaturated bonds. (B2) monomers can be selected from a first set of monomers selected from dimethacrylates such as ethylene glycol dimethacrylate, 1,3-butanediol dimethacrylate, 1,4-butanediol dimethacrylate; diacrylates like butylene glycol diacrylate; triacrylates like trimethylolpropane triacrylate (TMPTA), and di-vinyl compounds like divinyl benzene. Monomers of component (B2) can also be selected from a second set of monomers such as diallyl methacrylate, allyl methacrylate, allyl acrylate and the like. The dimethacrylates, divinyl benzene, and allyl (meth)acrylate are preferred. 1,3-Butanediol dimethacrylate, divinyl benzene and allyl methacrylate are most preferred. Monomers of component (B2) can be selected from the first or second set of monomers alone, or as a combination of monomers from the first and second sets.

The molecular weight of the polymer (B) stage of the acrylic resin composition PAM can be in a wide range from 0.5 to 5.0 million Daltons, preferably 0.5 to 3.0 million Daltons as determined by gel permeation chromatography on the polymer (B) phase prepared without the presence of the B2 monomers onto the elastic polymer phase.

The PAM material can be used alone as a sole polymeric material, or may be compounded with other polymeric materials.

Preparation of PAM Material is disclosed in U.S. Pat. No. 3,681,475.

In the PAM material, the polymer (B) phase is prepared in the presence of (A) polymer phase. Polymer (A) is obtained by polymerizing 95.0 to 99.5 wt %, preferably 97.0 to 99.5 wt % of a first polymeric component (A1) of one or more mono-ethylenically unsaturated monomers selected from the group consisting of the alkyl acrylates having an alkyl group containing from 1 to 8 carbons; and 0.5-5.0 wt %, preferably, 0.5 to 3.0 wt % of one or more polyethylenically unsaturated monomers. The term polyethylenically unsaturated monomer refers to a monomer with more than one polymerizable double bond.

Polymer (A) and polymer (B) may be produced in any conventional polymerization process, e.g., in an emulsion process, gas phase systems, slurry processes, solution processes or mixed-phase processes. Preferably, suspension, emulsion or mini-emulsion process is utilized.

Polymer (A) can be prepared in one or more sequential process stages (reactors), where the material prepared on each stage can be varied within the described limits of the elastic polymer compositional details.

The polymer (B) phase is prepared in the presence of polymer (A) and is obtained by polymerizing one or more monoethylenically unsaturated monomers (B1) selected from the group of alkyl methacrylates having an alkyl group containing from 1 to 4 carbons. Optionally, the monoethylenically unsaturated monomers can also include other monomers selected from the group of alkyl acrylates and vinylbenzene or substituted vinylbenzenes. When present, the other monomers are included in an amount from 1.0 to 10.0 wt %, preferably, 1.0 to 5.0 wt %. Optionally, polymer (B) may contain 0.3-2.5 wt % of one or more polyethylenically unsaturated monomers (B2), where the unsaturated bonds can be similar of the same or differing reactivity. Preferably, polymer (B) is largely formed from methyl methacrylate. The polymer can be formed as a homopolymer or a copolymer with one or more different monomers, provided that the hard polymer maintain a Tg above 85° C., preferably, above 90° C.

The ratio of polymer (A)/(B) ranges from 50/50 to 90/10. More preferably, the ratio of polymer (A)/(B) is 60/40 to 90/10.

Other Polymeric Resins

The polymeric resin that can be compounded with the PAM compounds is selected from polylactic acid (PLA), halogenated polymers such as PVC homopolymers, PVC copolymers, and CPVC; rubbers such as SAN, ASA, CPE, EVA, ABS, polycarbonate and MBS; and conventional acrylic esters, such as poly(methyl methacrylate) polymers or mixtures thereof. PAM can be used as a sole polymeric material, or may be compounded with other polymeric materials or additives. When compounded with a polymeric resin, the polymeric composition comprises PAM in an amount from 16.0 to 99.9 wt % and the polymeric resin in an amount from 0.1 to 84.0 wt % based on the total weight of the composition. Preferably, PAM is present in an amount from 16.0 to 80.0 wt %, 25.0 to 75.0 wt % or 30.0 to 70.0 wt % PAM, with corresponding amounts of 20.0 to 84.0 wt %, 25.0 to 75.0 wt % or 30.0 to 70.0 wt % of the polymeric resin based on the total weight of the composition. Most preferably, the compounded composition contains 30.0 to 50.0 wt % PAM and 50.0 to 70.0 wt % of the polymeric resin based on the total weight of the composition. Preferably, the polymeric resin is selected from PVC homopolymers, CPVC, PVC copolymers, ASA, PLA or mixtures thereof. More preferably, the polymeric resin comprises PVC homopolymers, PVC copolymers, PLA or mixtures thereof. Most preferably, the polymeric resin comprises PLA and PVC homo-polymers.

Halogenated Polymers

Examples of halogen-containing polymers include polymers of vinyl chloride, of vinylidene chloride, vinyl resins whose structure contains vinyl chloride units, such as copolymers of vinyl chloride and alkylglycidyl acrylates, copolymers of vinyl chloride and vinyl esters of aliphatic acids; in particular vinyl acetate, copolymers of vinyl chloride with esters of acrylic or methacrylic acid and with acrylonitrile, copolymers of vinyl chloride with diene compounds and with unsaturated dicarboxylic acids or anhydrides of these, such as copolymers of vinyl chloride with diethyl maleate, diethyl fumarate or maleic anhydride, post chlorinated polymers and copolymers of vinyl chloride, copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and copolymers of the same with vinyl chloride and with other polymerizable compounds; polymers of vinyl chloroacetate and of dichlorodivinyl ether; chlorinated polymers of vinyl acetate, chlorinated polymeric esters of acrylic acid and of α-substituted acrylic acid; polymers of chlorinated styrenes, such as dichlorostyrene; chlorinated rubbers; chlorinated polymers of ethylene; polymers and post chlorinated polymers of chlorobutadiene and copolymers of these with vinyl chloride, chlorinated natural or synthetic rubbers, and also mixtures of the polymers mentioned with themselves or with other polymerizable compounds. Preferably, the halogenated polymer is homopolymer PVC and chlorinated PVC (CPVC).

Rubbers

When the polymeric resin is selected from rubbers, the rubbers can be styrene-butadiene rubber (SBR), acrylonitrile-butadiene-styrene (ABS), polymethacrylate butadiene styrene (MBS), Acrylonitrile-Butadiene Rubber (NBR), styrene-acrylonitrile (SAN), ethylene-vinyl acetate (EVA), chlorinated polyethylene (CPE), ethylene-propylene diene monomer (EPDM), acrylonitrile-acrylate (NAR) and grafted acrylonitrile-styrene-acrylate (ASA). The rubbers can be present alone or as mixtures with PVC or the graft polymers of PVC and EVA, ABS or MBS.

Additives

The compositions of the present disclosure may include one or more additives to enhance or modify chemical or physical properties, such as hardness, heat stability, lubricity, color, or viscosity. Exemplary additives include, but are not limited to, plasticizers, heat stabilizers, process aids, lubricants, UV absorbers, antioxidants and antimicrobials among others known to be conventionally used in PVC formulations. An overview of these can be found in Plastics Additives Handbook, 4th edition, editors: R. Gächter and H. Müller, associate editor: P. P. Klemchuk; Hanser Publishers, Munich, (1993) and Plastics Additives and Modifiers Handbook, ed. J. Edenbaum; Van Nostrand Reinhold, (1992), which are incorporated by reference herein in their entirety.

Heat Stabilizers

Heat stabilizers can be used with compositions of the present disclosure containing PAM material.

Polyols and Other Organic Components

Suitable compounds of this type include sorbitol, triethanolamine, polyethylene glycols, β-diketones, such as stearoyl-benzoylmethane, and uracils. The polyols are used in amounts from 0.01 to 20 parts by weight, preferably from 0.1 to 10 parts by weight, and more preferably from 0.1 to 5 parts by weight, based on 100 parts by weight of the total PAM-containing compositions.

Hydrotalcite Co-Stabilizers

The chemical composition of these compounds are known to those of ordinary skill in the art as disclosed in DE 3 843 581, EP 0 062 813 and WO 93/20135, each of which is herein incorporated by reference in its entirety. The hydrotalcite co-stabilizers are used in amounts from 0.1 to 10.0 parts by weight, based on the total weight of the composition.

Compounds from the hydrotalcite series may be described by the following general formula:

M²⁺₁₋ₓM³⁺ₓ(OH)₂(A^{b-})_{x/b}.dH₂O,

where

a. M²⁺=one or more of the metals selected from the group consisting of Mg, Ca, Sr,

Zn and Sn,

b. M³⁺=A1 or B,

c. A^{b} is an anion of valency b,

d. b is a number from 1-2,

e. 0<x<0.5, and

f. d is a number from 0-20.

Preferably, A^{b} is selected from OH⁻, ClO₄⁻, HCO₃⁻, CH₃COO⁻, C₆H₅COO⁻, CO₃²⁻, (CHOHCOO)₂²⁻, (CH₂COO)₂²⁻, .CH₃CHOHCOO⁻, HPO₃⁻ or HPO₄²⁻. Examples of hydrotalcites include Al₂O₃. 6MgO.CO₂.12H₂O, Mg₄. 5Al₂(OH)₁₃.CO₃. 3.5H₂O, 4MgO.Al₂O₃CO₂. 9H₂O, 4MgOAl₂O₃.CO₂6H₂O, ZnO-3MgO.Al₂O₃ CO₂.8-9H₂O and ZnO₃MgOAl₂O₃CO₂. 5-6H₂O.

Metal Soap Stabilizers

Metal soaps are primarily metal carboxylates, preferably of relatively long-chain carboxylic acids. Well-known examples are stearates, oleates, palmitates, ricinolates, hydroxystearates, dihydroxy-stearates and laurates.

Exemplary metals include alkali, alkaline earth and rare earth metals. Preferably, the metals are selected from Na, K, Mg, Ca, Sr, Ba, Pb, Zn, Al, La, or Ce. Use is frequently made of so-called synergistic mixtures, such as barium/zinc stabilizers, magnesium/zinc stabilizers, calcium/zinc stabilizers or calcium/magnesium/zinc stabilizers. The metal soaps may be used either alone or in mixtures. An overview of common metal soaps is found in Ullmann's Encyclopedia of Industrial Chemistry, 5th Ed., Vol. A16 (1985), pp. 361 et seq, which is incorporated by reference herein in its entirety.

The metal soaps or mixtures thereof may be used in amounts of, for example, 0.001 to 10 parts by weight, preferably, 0.01 to 8 parts by weight, more preferably 0.05 to 5 parts by weight, based on 100 parts by weight of the total PAM-containing composition

Alkali Metal and Alkaline Earth Metal Compounds

For the purposes of the present disclosure, examples of these materials include the carboxylates of the acids described above, but also the corresponding oxides, hydroxides or carbonates. Mixtures of these with organic acids are also possible. Examples include NaOH, KOH, CaO, Ca(OH)₂, MgO, Mg(OH)₂, BaO, Ba(OH)₂, Sr(OH)₂, Al(OH)₃, CaCO₃, MgCO₃ and the basic carbonates, as well as selected salts of Na and of K, including perchlorates. In the case of alkaline earth carboxylates and Zn carboxylates, it is also possible to use adducts of these as so-called “overbased” compounds. The alkali metal and alkaline earth metal compounds may be used in amounts of 0.1 to 10.0 based on the total weight of the PAM-containing composition.

Alkali Alumosilicates (Zeolites)

Zeolite co-stabilizers are described by the general formula: M_{x/n}[(AlO₂)x(SiO₂)_{y}]wH₂O, wherein n is the charge of the cation M, M is an element from the first or second main group of the Periodic Table, such as Li, Na, K, Mg, Ca, Sr or Ba, y and x are numbers that range from 0.8 to 15, preferably from 0.8 to 1.2; and w is a number from 0 to 300, preferably from 0.5 to 30. Examples of zeolites are sodium aluminosilicates of the following types: zeolite A, zeolite Y, zeolite X, zeolite LSX; or the zeolites prepared by complete or partial replacement of the Na atoms by Li, K, Mg, Ca, Sr or Zn atoms. The preferred Si/AI ratio is about 1:1. Preferred zeolites are Na zeolite A and Na zeolite P. The zeolites are used in an amount from 0.1 to 10.0 parts by weight based on 100 parts of the total PAM-containing composition.

Organotin Stabilizers

Examples of suitable compounds of this type include both mono- and dimethyl-, butyl- and octyltin mercaptides, and maleates. The organotin stabilizers are used in an amount from 0.1 to 10.0 parts by weight, based on 100 parts of the total PAM-containing composition.

Phosphites (Triesters of Phosphorous Acid)

Examples of these are triphenyl phosphite, diphenyl isodecyl phosphite, ethylhexyl diphenyl phosphite, phenyl diisodecyl phosphite, trilauryl phosphite, triisononyl phosphite, triisodecyl phosphite, epoxy grade triphenyl phosphite, diphenyl phosphite, and tris(nonylphenyl) phosphite. Advantageous use may also be made of phosphites of various di- or polyols.

Preferably, the organic phosphites are used in amounts from 0.01 to 10 parts by weight, more preferably from 0.05 to 5.0, and most preferably from 0.1 to 3.0 parts by weight, based on 100 parts by weight of the total PAM-containing composition.

Metal Perchlorates

Metal perchlorates can be added into compounds comprising PAM. The perchlorates can be introduced into the compounds (prior to a compounding step) as pure solid salts or preferably as solutions in alcohols and/or alcohol derivatives. Suitable solvents to provide the solutions are 2-(2-butoxyethoxy)ethanol or water or polyethylene glycol. Representative examples of metal perchlorates include alkali metal, alkaline earth metal, aluminum, zinc, lanthanum or cerium metal perchlorates. Preferred are alkali metal perchlorates. More preferred are sodium and potassium perchlorates. In some embodiments, the metal perchlorates are provided as metal perchlorate hydrates. Exemplary hydrates are monohydrates, dihydrates, trihydrates and tetrahydrates. Perchlorate solutions are commercially available. For example, Galata Chemicals manufactures Mark CE-350, a sodium perchlorate solution.

Plasticizers

PAM may contain one or more conventional plasticizers and their blends. Exemplary conventional plasticizers are branched and linear ortho- and tere-phthalates, hydrogenated phthalates, aliphatic esters of dicarboxylic acids, polymeric esters of dicarboxylic acids, citrates, sucrose esters, levulinic ketal esters, phosphates, alkyl phenol sulfonates, pyrrolidones, trimellitates, esters of benzoic acid, epoxidized oils, epoxidized mono-esters of fatty acids, dialkylthiodiesters and the like. An overview of conventional plasticizers is found at PLASTICS ADDITIVES HANDBOOK, 4th edition, ed. Gächter/Müller, Hansa Gardner Publishers, Munich, 1993, pg. 327-422, which is incorporated by reference herein in its entirety. Preferably, the conventional plasticizers are selected from the group consisting of phthalates, substantially fully esterified mono-, di- and tribasic acids, adipates, azelates, succinates, glutarates, glycol esters, sucrose esters, levulinic ketal esters, citrates, phosphates, alkyl phenol sulfonates, pyrrolidones, epoxidized esters and mixtures thereof. The plasticizers are added at 1.0-70.0 phr, preferably at 10.0 to 40.0 phr to make PAM softer, reducing its hardness (as measured via Durometer Type A) from 93 to 50 (without the presence of fillers and reinforcing additives).

UV Absorbers/Light Stabilizers

Examples of UV absorbers and light stabilizers include 2-(2′-hydroxyphenyl)benzotriazoles, such as 2-(2′-hydroxy-5′-methylphenyl)-benzotriazole, 2-hydroxybenzophenones, esters of unsubstituted or substituted benzoic acids, such as 4-tert-butylphenyl salicylate, phenyl salicylate, acrylates, nickel compounds, oxalamides, such as 4,4′-dioctyloxyoxanilide, 2,2′-dioctyloxy-5,5′-ditert-butyloxanilide, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, sterically hindered amines, such as bis(2,2,6,6-tetramethylpiperidin-4-yl) sebacate, bis(2,2,6,6-tetramethylpiperidin-4-yl) succinate. Mixtures of the UV absorbers and/or light stabilizers may also be used. The UV absorbers and light stabilizers are added to the PAM-containing composition at 0.01-1.0 parts by weight, based on 100 parts by weight of the total PAM-containing compositions.

Antioxidants

Exemplary embodiments include alkylated monophenols, e.g., 2,6-di-tert-butyl-4-methylphenol, alkylthiomethylphenols, e.g., 2,4-dioctylthiomethyl-6-tert-butylphenol, alkylated hydroquinones, e.g., 2,6-di-tert-butyl-4-methoxyphenol, hydroxylated thiodiphenyl ethers, e.g., 2,2′-thiobis(6-tert-butyl-4-methylphenol), alkylidenebisphenols, e.g., 2,2′-methylene-bis(6-tert-butyl-4-methylphenol), benzyl compounds, e.g., 3,5,3′,5′-tetratert-butyl-4,4′-dihydroxydibenzyl ether, hydroxybenzylated malonates, e.g., dioctadecyl 2,2-bis(3,5-di-tert-butyl-2-hydroxybenzyl)malonate, hydroxybenzyl aromatics, e.g., 1,3,5-tris(3,5-di-tert-butyl-4-hydroxybenzyl)-2,4,6-trimethylbenzene, triazine compounds, e.g., 2,4-bisoctylmercapto-6-(3,5-di-tert-butyl-4-hydroxyanilino)-1,3,5-triazine, phosphonates and phosphonites, e.g., dimethyl 2,5-di-tert-butyl-4-hydroxybenzylphosphonate, acylaminophenols, e.g., 4-hydroxylauranilide, esters of β-(3,5-ditert-butyl-4-hydroxyphenyl)propionic acid, e.g., pentaerythritol tetrakis(3-(3,5-di-tert-butyl-4-hydroxyphenyl)propionate), octadecyl-3-(3,5-di-tert-butyl-4-hydroxyphenyl)propionate, β-(5-tert-butyl-4-hydroxy-3-methylphenyl)propionic acid, β-(3,5-dicyclohexyl-4-hydroxyphenyl)propionic acid, esters of 3,5-ditert-butyl-4-hydroxyphenylacetic acid with mono- or polyhydric alcohols, amides of β-(3,5-ditert-butyl-4-hydroxyphenyl)propionic acid, such as, for example, N,N′-bis(3,5-ditert-butyl-4-hydroxyphenyl-propionyl)hexamethylenediamine, vitamin E (tocopherol) and derivatives. Mixtures of antioxidants may also be used.

The antioxidants are typically used in amounts from 0.01 to 10 parts by weight, preferably, from 0.1 to 5 parts by weight, and more preferably from 0.1 to 3 parts by weight, based on 100 parts by weight of the total PAM-containing polymer resins.

Pigments

Suitable pigments are known to those of ordinary skill in the art, and include inorganic pigments such as TiO₂, pigments based on zirconium oxide, BaSO4, and zinc oxide (zinc white). Mixtures of various pigments may also be used, e.g., as shown in the “Handbook of PVC Formulating”, E. J. Wickson, John Wiley & Sons, New York, 1993, which is herein incorporated by reference in its entirety. The pigments are typically used in amounts from 1 to 200 parts by weight, based on 100 parts by weight of the total PAM-containing polymer resins.

Fillers

Suitable fillers include calcium carbonate, dolomite, wollastonite, magnesium oxide, magnesium hydroxide, silicates, china clay, talc, glass fibers, glass beads, wood flour, mica, metal oxides or metal hydroxides, carbon black, graphite, rock flour, heavy spar, glass fibers, talc, kaolin and chalk may be used in accordance with some embodiments of the present invention, as in the HANDBOOK OF PVC FORMULATING, E. J. Wickson, John Wiley & Sons, Inc., 1993, pp. 393-449; see also TASCHENBUCH der Kunststoffadditive [Plastics Additives Handbook], R. Gächter & H. Müller, Carl Hanser, 1990, pp. 549-615), both of which are hereby incorporated by reference in their entirety.

The fillers are preferably used in amounts of 1 to 20 parts by weight, more preferably, 1 to 10 parts by weight, and even more preferably from 1 to 5 parts by weight, based on 100 parts by weight of the total PAM-containing compositions.

Preparation of Composition Mixtures

The polymeric resin, PAM material and additives may be combined via compounding steps, such as molding (injection molding, compression molding, blow molding), calendaring or extrusion.

The compositions containing polymeric resin, PAM material and optional additives can be fabricated into articles including film, sheet, foamed sheet, flooring, weatherable exterior, siding capstock, doors, decking, profiles, roofing, automotive, packaging, medical devices, toys or waterproofed articles. Such articles can be produced via molding, calendaring or extrusion as discussed above.

Articles produced using the compositions of the present disclosure preferably have a hardness measured by ASTM D2240 of 80.0 to 95.0. The articles also preferably have a volatility measured as a percent weight loss at 100° C. over 24 hours, ranging from 0.5 to 2.5%. The articles preferably also have a haze value, measured by ASTM D1003 of greater than 2%.

The articles produced using the compositions of the present disclosure preferably have a gravimetric fog (measured in accordance with SAE J1756, ISO 6452, DIN 75201) of <30%. The articles also have a surface resistivity (as measured in accordance with ASTM D 257-91) that preferably ranges from 10¹¹ to 10¹⁵ Ohm/sq. Further, the articles preferably have a low temperature brittle point (as measured in accordance with ASTM D 746) ranging from −25 to −45° C.

A compound produced from PAM as the sole polymeric material has an elongation at break >120% as measured in accordance with ASTM D638.

The PAM material can be blended with additives. In another embodiment the present disclosure provides a composition comprising: (1) a polyacrylate resin/material (PAM) composition comprising a polymer (A) phase and a polymer (B) phase present in a ratio of polymer (A) phase/polymer (B) phase of 50/50 to 90/10. Polymer (A) has a glass transition temperature Tg below −40° C., and comprises 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers. Polymer (B), has a glass transition temperature Tg above 85° C., and comprises a first polymeric component (B1) and an optional second component (B2). First polymeric component (B1) contains one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof. Optional second polymeric component (B2) comprises 0.3 to 2.5 wt % based on the total weight of polymer (B) of one or more polyethylenically unsaturated monomers where the unsaturated bonds can be of the same or differing reactivity; and (2) an additive selected from plasticizer, heat stabilizer, UV absorber or mixtures thereof.

The additives used in compositions with the PAM material are as described above.

### EXAMPLES

The following examples further detail and explain the performance of the inventive compositions. Those skilled in the art will recognize many variations that are within the spirit of the invention and scope of the claims.

### Example of PAM Synthesis (SEA16-10)

SEA 16-10 was prepared in accordance with U.S. Pat. No. 3,681,475 (Example 1) C.

Sample Preparation

Tested formulations of Table 1 included the following components and raw materials:

| Components/Raw | | | |
|---|---|---|---|
| materials | Trade name | Manufacturer | Loadings |
| PVC resin | Oxy-450 | Occidental | 60-100% |
| | | Petroleum | |
| Polyacrylate | SEA16-10 | Galata | 40-100% |
| material/resin (PAM) | | Chemicals | |
| Liquid Ba/Zn heat | Mark 9502 | Galata | 2.5 phr |
| stabilizer | | Chemicals | |
| UV absorber | Tinuvin-234 | BASF Corp. | 0.2 phr |
| Lubricant Plasticizers | Stearic acid | PMC Group | 0.2 phr |
| (see Table 1) | | | |

Tested plasticizers included the following:

Epoxidized soybean oil (ESBO) marketed by Galata Chemicals, LLC as Drapex® 6.8.

Epoxidized 2-ethylhexyl soyate (EOS) was synthesized via esterification of soy fatty acids with 2-ethylhexanol followed by the epoxidation with hydrogen peroxide in the presence of formic acid.

Di(2-ethylhexyl)-tere-phthalate (DOTP) and trioctyl trimellitate (TOTM) were received from Aldrich.

When several types of resins were used (such as PVC and PAM) in one compound their concentrations were expressed as percent of total resin amount in the compound. Loadings of additives were expressed in parts per 100 parts of a total amount of all resins.

For the conversion of the powder form of the polymer-containing formulations into a usable form, a sheet was prepared under standardized conditions using a two-roll mill (Dr. Collin GmbH, Ebersberg, Germany). The gap between the rolls was about 0.5 mm; the temperature of the rolls 165° C.; the time for preparation and homogenization: 5 minutes; and the sheet thickness was 0.5 mm. The sheet was continuously moved from the two sides to the center and the enlargement thus obtained was distributed over the gap with a wooden spatula over the roll with intensive homogenization of all components.

TABLE 1
Tested PAM- and PVC-containing formulations

| | | | Plasticizer |
|---|---|---|---|
| Example | Polymeric | | Content, |
| Number | Materials | Plasticizer | phr/% |
| 1 (control) | PVC | NA | 0 |
| 2 | SEA16-10 | NA | 0 |
| 3 (control) | PVC | DOTP | 20 phr/17% |
| 4 (control) | PVC | DOTP | 40 phr/29% |
| 5 | SEA16-10 | ESBO | 25 phr/20% |
| 6 | SEA16-10 | 50/50 ESBO/EOS | 25 phr/20% |
| 7 | SEA16-10 | EOS | 25 phr/20% |
| 8 | SEA16-10 | EOS | 67 phr/40% |
| 9 | SEA16-10 | TOTM | 25 phr/20% |
| 10 | SEA16-10 | TOTM | 67 phr/40% |
| 11 | SEA16-10 | DOTP | 25 phr/20% |
| 12 | SEA16-10 | DOTP | 67 phr/40% |
| 13 | 50/50 | DOTP | 25 phr/20% |
| | SEA16-10/PVC | | |
| 14 | 50/50 | DOTP | 50 phr/33% |
| | SEA16-10/PVC | | |

Testing of Compounded Materials

Shore A Hardness

Shore A Hardness of the formulations was determined in accordance with ASTM D2240, using a commercially available Durometer Type A hardness tester (Shore Instrument & Mfg Co, Jamaica, N.Y., USA). The tested samples were prepared in accordance with the sample preparation technique described above. Shore A Hardness results were measured in triplicates. Table 2 contains an average of the three readings. A lower number indicates a softer material.

TABLE 2
Shore A Hardness of tested compounds

| Example Number | Shore A Hardness |
|---|---|
| 1 (control) | 96 |
| 2 | 93 |
| 3 (control) | 93 |
| 4 (control) | 87 |
| 5 | 83 |
| 6 | 84 |
| 7 | 85 |
| 8 | 65 |
| 9 | 86 |
| 10 | 75 |
| 11 | 88 |
| 12 | 70 |
| 13 | 93 |
| 14 | 87 |

Results of Table 2 indicate that Shore A Hardness of the non-plasticized PAM was 93, while Shore A Hardness of the plasticized PAM ranged from 70 (Example 12) to 88 (Example 11), using DOTP as a plasticizer. Hardness imparted by EOS, TOTM and ESBO plasticizers on PAM was within the 70-88 range.

It was discovered that compared with non-plasticized PVC, PAM is softer (compare Shore A Hardness of 96 and 93 of Examples 1 and 2, respectively). In comparison with plasticized PVC, however, PAM plasticized with the same plasticizers added at the same levels was found to be significantly softer. For example, Shore A Hardness of PVC and PAM samples plasticized with 20% DOTP was 93 and 88 (Examples 3 and 11), respectively; Shore A Hardness of PVC and PAM samples plasticized with 40% DOTP was 87 and 70 (Examples 4 and 12), respectively. These examples demonstrate that in addition to being softer than PVC, PAM is more flexible than rigid PVC and/or uniquely “more effectively plasticizable” (it can be defined as a hardness change imparted by the same amount of a plasticizer) compared with PVC.

Bio-Based Compounds and their Bio-Based Content

Since epoxidized ester of fatty acids EOS and ESBO are produced from renewable feedstock, plasticization of PAM with the use of biobased plasticizers results in bio-based PAM-containing compounds and enables attaining acrylic materials of 11-21% biobased content as calculated based on renewable carbon content (or could be measured via ASTM D6866) as shown in Table 3.

TABLE 3
Calculated bio-based content of selected
plasticized PAM-containing compounds

| Example Number | Calculated bio-based content, % |
|---|---|
| 5 | 20 |
| 6 | 18 |
| 7 | 11 |
| 8 | 21 |

It is known that processing CPVC resins is a difficult task, while incorporation of conventional plasticizers into CPVC in order to soften it and improve its processability is challenging due to incompatibility of the plasticizers with CPVC. In reality, it is known that CPVC is susceptible to environmental stress cracking by phthalate plasticizers. Unexpectedly, semi-rigid and flexible CPVC compounds were prepared in accordance with formulations of Table 4 by combining CPVC and PAM resins and processed on the two-roll mill as described above. Shore A Hardness values of the obtained CPVC-PAM specimens are shown in Table 4 also.

TABLE 4
Tested PAM-CPVC formulations and their hardness

| Example | Polymeric | Polymer | Shore A |
|---|---|---|---|
| Number | Materials | Composition, % | Hardness |
| 15 (control) | CPVC | 100 | >100 |
| 16 | CPVC/SEA16-10 | 80/20 | 90 |
| 17 | CPVC/SEA16-10 | 75/25 | 86 |
| 18 | CPVC/SEA16-10 | 70/30 | 93 |
| 19 | CPVC/SEA16-10 | 60/40 | 95 |

CPVC resin (CPVC H829 from Kaneka); stabilized with 2.5 phr Mark 292 stabilizer is marketed by Galata Chemicals, LLC.

Results of Table 4 demonstrate that incorporation of PAM at concentrations ranging from 20 to 40% into the standard rigid CPVC resin resulted in the formation of semi-rigid (Example 18 and 19 of 93 and 95 Shore A Hardness, respectively) and flexible (Examples 16 and 17 of 90 and 86 Shore A Hardness, respectively) processable compounds.

Volatility

Volatility of the compounded milled sheets (thickness of 0.5 mm) was calculated as a percent weight loss upon exposing the prepared milled sheet chips (25×25 mm) to 100° C. temperature over a 24 hour period of time. Weights were recorded using an analytical balance, and the results were measured in triplicates. Table 5 shows an average of the three readings.

TABLE 5
Weight loss (Volatility) of the selected compounds
(% weight loss at 100° C. over 24 hours)

| | | % | Volatility reduction |
|---|---|---|---|
| Example | Shore A | Weight | against Example 4 |
| Number | Hardness | Loss | (control), % |
| 4 (control) | 87 | 2.61 | N/A |
| 7 | 85 | 1.45 | 44 |
| 11 | 88 | 1.73 | 34 |
| 14 | 87 | 1.83 | 30 |

Volatility of various materials is normally assessed at comparable hardness. While materials of Example 4 (plasticized PVC) and Example 11 (plasticized PAM) contain different amounts of DOTP, the Shore A Hardness of those materials is within experimental error (87 and 88, respectively), and as showed in Table 3, volatility of those samples were 2.61 and 1.73%, respectively. Therefore, in comparison with the plasticized PVC, volatility of the plasticized (with DOTP) PAM of comparable hardness was reduced by about 34%. The volatility of Examples 7 and 14 in comparison with Example 4 (control) of similar hardness was reduced by 44 and 30%, respectively.

Gravimetric Fog Test

Fogging Characteristics of Interior Automotive Materials (Gravimetric or Photometric) are determined in accordance with SAE J1756, ISO 6452, DIN 75201.

Fogging tests measure the tendency for plastic or elastomeric materials to release substances which can condense and collect on other surfaces when in use. The gravimetric method assesses the likelihood of a material to deposit foreign material onto an aluminum foil surface. The test is used to evaluate materials to be used in automotive interiors.

The test sample is placed in a sealed beaker—the inside surface of the cooled beaker cover is aluminum foil. The bottom of the beaker is placed in a controlled temperature oil bath for 16 hours. The weights of the test sample and the aluminum foil before the test and immediately after the test are compared.

Results of measuring Gravimetric Fog on materials of comparable hardness are shown in Table 6.

TABLE 6
Gravimetric Fog of selected materials

| | | | Gravimetric Fog |
|---|---|---|---|
| | | | reduction against |
| Example | Shore A | Gravimetric | Example 4 |
| Number | Hardness | Fog, % | (control), % |
| 4 (control) | 87 | 33.3 | N/A |
| 7 | 85 | 22.0 | 34 |
| 11 | 88 | 21.4 | 36 |
| 14 | 87 | 25.0 | 25 |

Similar to volatility, in comparison with the plasticized PVC, volatility of the plasticized (with DOTP) PAM of comparable hardness was reduced by about 36% (see Examples 4 and 11 in Table 4). The volatility of Examples 7 and 14 in comparison with Example 4 (control) of similar hardness was reduced by 34 and 25%, respectively.

Flexibility of Compounds at Low Temperatures

The brittleness temperature was measured in accordance with ASTM D 746, using a Tinius Olsen Brittleness Tester. A specimen was prepared via milling the compound as described above, compression-molding it into a plaque with the use of a Wabash press, and then cutting the plaque using a cutting die of 2.5 in ×0.25 in ×0.075 in. The temperature was controlled using a dry ice/acetone bath. Results of the test are listed in Table 7.

TABLE 7
Low Temperature Brittleness Point (° C.)

| Example 2 | Example 5 | Example 6 | Example 7 |
|---|---|---|---|
| −34.6 | −31.4 | −36.6 | −42.6 |

Results of Table 7 show that both non-plasticized (Example 2) and plasticized (Examples 5-7) PAM materials exhibit excellent flexibility at low temperatures and, therefore and impart a relatively low, Low Temperature Brittleness Point (compared with PVC of Example 1 that is known to be very brittle at low temperatures) that enable using articles made from PAM-containing materials in colder climate conditions.

Elongation

It was also shown that in addition to enhanced flexibility at low temperature, PAM, exhibited unusually high elongation at break. It was tested in accordance with ASTM D638. Elongation at break of PAM (Example 2) was found to be 133%, which was considerably greater than PVC (<15%).

Surface Resistivity

Surface resistivity of the compounds was measured in accordance with ASTM D 257-91. The surface resistivity results for the tested compounds are expressed in Ohm/square in Table 8.

TABLE 8
Surface Resistivity

| Example Number | Surface Resistivity, Ohm/sq |
|---|---|
| 3 (control) | 4.32E+16 |
| 4 (control) | 1.73E+15 |
| 5 | 9.62E+12 |
| 7 | 4.70E+13 |
| 8 | 6.30E+12 |
| 10 | 9.81E+12 |
| 11 | 1.45E+13 |
| 12 | 8.24E+12 |
| 13 | 1.26E+13 |
| 14 | 3.53E+13 |

Results of Table 8 show that surface resistivity of all PAM-containing materials (Example 5, 7, 8, and 10-14) was substantially (at least 10 times; most commonly more than 100 times) lower than that of the plasticized PVC (Example 3, 4 controls), demonstrating that PAM is inherently a more conducting material than PVC. Therefore, PAM-containing specimens dissipate static electricity very effectively and may not require as much as antistatic agents to prevent static electricity build ups. It shows that PAM-containing materials are inherently safer than those that require the addition of antistatic agents to dissipate the static electricity.

Static Heat Stability

Static heat stability of compounds containing PAM and described in Table 1 was determined by milling the dry blends into sheets. The sheets were prepared under standardized conditions using a two-roll mill (Dr. Collin GmbH, Ebersberg, Germany) as described above. For measuring yellow color intensity in Yellowness Index, 15 mm wide strips were cut from each milled sheet such that eight rectangular samples (15 mm×10 mm) from each sheet were produced. The samples were placed in an oven (Blue M Company, New Columbia, Pa., USA) operating at 190° C. for thermal aging. The samples were removed from the oven at the rate of one sample every ten minutes. Assessment of the thermal stability of the compounds was carried out by determining the discoloration. The Yellowness Index (ASTM D 1925-70 Yellowness Index of plastics) was measured and recorded for each sample using the microprocessor Hunterlab Labscan Spectro Colorimeter, Type 5100. The lower Yellowness Index the better the heat imparted discoloration of the compound.

Results of the static heat stability test on selected PAM-containing compounds are in Table 9.

TABLE 9
Static heat stability test (Yellowness Index)
on the selected PAM-containing compounds

| Time, | | | | |
|---|---|---|---|---|
| min | Sample 2 | Sample 2* | Sample 5 | Sample 5* |
| 0 | 48.88 | 27.60 | 34.17 | 15.15 |
| 10 | 64.84 | 39.51 | 56.44 | 21.84 |
| 20 | 72.34 | 45.45 | 62.76 | 30.90 |
| 30 | 75.19 | 44.15 | 64.30 | 35.67 |
| 40 | 76.88 | 47.65 | 67.91 | 38.10 |

All formulations contained 0.20 phr Tinuvin 234 (UV absorber supplied by BASF Corporation)
*The formulations also contained 0.25 phr Mark CE-350.

The results of Table 9 showed that the heat stability of PAM (both non-plasticized Example 2 and EOS plasticized Example 5) was considerably improved in the presence of sodium perchlorate (Example 2* and Example 5*, respectively). The corresponding Yellowness Index values are shown to be considerably lower in the presence of Mark CE-350. This is an unexpected phenomenon for polymeric acrylic compounds.

UV light Stability

Compound were prepared for accelerated UV stability test by compounding a dry blend of the components in a two-roll testing mill, type W 150EP for 5 minutes at 177° C. and 30 rpm roll speed. After 5 minutes, the milled rigid PVC sheets were taken off the instrument and flattened while still warm with a Ferro plate, to obtain a smooth, flat surface. Ten individual rigid sheet specimens were then cut to fit a standard 3″×12″ panel and secured by snap-in rings. The samples were then placed in a QUV Solar Eye accelerated weathering tester (manufactured by Q-Lab Corporation, Westlake, Ohio) and exposed to conditions under ASTM G-154 using a 340 nm UVA lamp. The programmed QUV consisted of 8 Hours of UV-light exposure 60° C., followed by 4 Hours of condensation at 50° C. Individual samples were taken at 125 hour intervals and measured for color development (Yellowness Index—YI) using a Hunter ColorQuest II Colorimeter (manufactured by Hunter lab, Reston, Va.). Results of the UV light stability testing are in Table 10.

TABLE 10
UV light stability test on the selected PAM-containing compounds

| Time, | Example 3 | | | | |
|---|---|---|---|---|---|
| hours | (control)^{a} | Sample 7 | Example 7^{a} | Example 6 | Example 6^{b} |
| 125 | 3.66 | 27.34 | 2.66 | 22.99 | 0.41 |
| 250 | 6.38 | 34.99 | 2.12 | 31.04 | 0.24 |
| 375 | 6.62 | 39.84 | 2.57 | 39.03 | 0.51 |
| 625 | 15.29 | 43.66 | 1.94 | 45.53 | 1.60 |

^{a}The formulation also contained 0.20 phr Tinuvin 234 (UV absorber supplied by BASF Corporation)
^{b}The formulation also contained both 0.20 phr Tinuvin 234 and 0.25 phr Mark CE-350

Results of Table 10 show that even in the presence of a UV absorber (Tinuvin 234) in the plasticized PVC (Example 3a—control) the yellow color becomes more pronounced under the test conditions at 625 hours. Comparison between Example 7 and 7a demonstrate that the presence of the UV absorber in the plasticized PAM considerably reduces color development under the test conditions. The color development was reduced even further when a combination of both the UV absorber and sodium perchlorate were added to the PAM formulation (compare Example 6 and Example 6 ab).

Transparency/Opacity

Transparency (opacity) of PAM and its combinations with PLA and in certain examples calcium carbonate was measured as % Transmittance and % Haze. The specimens were blended together (as described in Table 11) and fused into homogenous mixtures using a Brabender Intellitorque Plasti-Corder torque rheometer (with 3-piece mixer and roller blades; 170° C., 40 rpm in accordance with ASTM D2538). The fused materials were removed and pressed into flat specimens. A 6 g portion of the fused and flattened material was taken and pressed into a disk with 1 mm thickness using a mold and the Wabash hydraulic heat/cool press (Model: 30-1512-2T2WCMB), where the platens were maintained at a temperature of 190° C. for 1 min and then cooled down to 50° C., maintaining a pressure of 3.1 MPa.

The % Haze and % Total Transmittance were measured on a Hunter Lab Color Quest 11 colorimeter. Results are shown in Table 11.

TABLE 11
Transparency of selected compounds

| Example | Resin Composition | Weight % | % Transmittance | % Haze |
|---|---|---|---|---|
| 15 | PLA (control) | 100 | 95.1 | 37.9 |
| 16 | SEA 18-01* | 100 | 91.6 | 29.7 |
| 2 | SEA 16-10** | 96* | 71.8 | 89.2 |
| 17 | SEA 18-01/PLA | 80/20 | 88.9 | 34.7 |
| 18 | SEA 18-01/PLA | 60/40 | 83.9 | 62.1 |
| 19 | SEA 18-01/PLA | 40/60 | 84.7 | 69.4 |
| 20 | SEA 18-01/PLA | 20/80 | 87.5 | 76.0 |

*SEA 18-01 was prepared the same way as SEA 16-10 but without calcium carbonate;
**contained 4% calcium carbonate

Results of Table 11 show that PAM of Example 16 exhibited % transmittance of slightly above 90, while % Transmittance of combinations of PAM with PLA (Examples 17-20) was <90%; % Transmittance was the lowest for a sample containing calcium carbonate (Example 2). It can also be concluded that % Transmittance can be controlled with addition of another polymer and/or a filler. % Haze of all the tested specimens was >30 and ranged from 34.7% for Example 16 to 89.2% for Example 2.

Other features, advantages and embodiments of the invention disclosed herein will be readily apparent to those exercising ordinary skill after reading the foregoing disclosure. In this regard, while specific embodiments of the invention have been described in considerable detail, variations and modifications of these embodiments can be affected without departing from the spirit and scope of the invention as described and claimed.

What is claimed:

1. A composition comprising:
(1) a polyacrylate resin/material (PAM) composition comprising a polymer (A) phase and a polymer (B) phase present in a ratio of polymer (A) phase/polymer (B) phase of 50/50 to 90/10,
polymer (A), having a glass transition temperature Tg below −40° C., comprising 95.0 to 99.5 wt % of a first polymeric component (A1) of one or more mono-ethylenically unsaturated monomers selected from the group consisting of alkyl acrylates having an alkyl group containing from 1 to 8 carbons, and 0.5 to 5.0 wt % of a second polymeric component (A2) of one or more polyethylenically unsaturated monomers, where the double bonds can be of the same or differing reactivity; and
polymer (B), having a glass transition temperature Tg above 85° C., comprising a first polymeric component (B1) of one or more monoethylenically unsaturated monomers selected from the group consisting of alkyl methacrylates having an alkyl group containing from 1 to 4 carbons, and optionally, 1.0 to 10.0 wt % of other monomers, based on the total weight of the (B1) component, selected from alkyl acrylates, vinylbenzene or substituted vinylbenzenes or mixtures thereof, and optionally a second polymeric component (B2) comprising 0.3 to 2.5 wt % based on the total weight of polymer (B) of one or more polyethylenically unsaturated monomers where the unsaturated bonds can be of the same or differing reactivity; and
(2) an additive selected from a plasticizer, heat stabilizer, UV absorber or mixtures thereof.

2. The composition of claim 1 wherein the additive is a UV absorber present in amount of 0.02 to 2 parts per hundred based on the total weight of the composition.

3. The composition of claim 1 wherein the additive is a plasticizer present in an amount from 5.0 to 100.0 parts per hundred based on the total weight of the composition.

4. The composition of claim 1 wherein the additive is a heat stabilizer present in an amount from 0.01 to 10 parts per hundred based on the total weight of the composition.

5. The composition of claim 4 wherein the heat stabilizer is a metal perchlorate.
